(19) United States
(12) Patent Application Publication
(10) Pub. No.: US 2012/0059977 A1
(43) Pub. Date: Mar. 8, 2012

(54) ELECTRONIC DEVICE, CONTROLLER FOR ACCESSING A PLURALITY OF CHIPS VIA AT LEAST ONE BUS, AND METHOD FOR ACCESSING A PLURALITY OF CHIPS VIA AT LEAST ONE BUS

(76) Inventor: Hai-Feng Chuang, Taipei County (TW)

(21) Appl. No.: 12/941,962

(22) Filed: Nov. 8, 2010

(30) Foreign Application Priority Data
Sep. 3, 2010 (TW) 099129871

(51) Int. Cl. G06F 12/00; G06F 12/02; G06F 13/00

(52) U.S. Cl. 711/103; 710/107; 711/E12.001; 711/E12.008

(57) ABSTRACT

An electronic device includes a plurality of chips, at least a bus and a controller, where the plurality of chips include a first chip and a second chip, the bus includes a plurality of data lines, the controller couples to the plurality of chips via the bus, and the controller is utilized for accessing the plurality of chips. The controller determines an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

### BACKGROUND OF THE INVENTION

1. Field of the Invention

The present invention relates to an electronic device, and more particularly, to an electronic device having a plurality of allocations for data transmission, a controller for accessing a plurality of chips via at least one bus, and a method for accessing a plurality of chips via at least one bus.

2. Description of the Prior Art

In a conventional flash memory device, a flash memory controller simultaneously transmits command signals, address signals and required data to a flash memory chip via a bus. However, because the command signals, the address signals and the required data are transmitted via the bus at the same time, each signal needs to be transmitted via a dedicated data line included in the bus. For a detailed illustration of this, please refer to FIG. 1. FIG. 1 is a diagram illustrating a prior art flash memory controller 102 connecting to a plurality of flash memory chips 104 and 106 via a bus 130. As shown in FIG. 1, pins D0-D7 of the flash memory controller 102 need to be respectively connected to pins D0-D7 of the flash memory chips 104 and 106 so as to make the flash memory chips 104 and 106 receive the correct signals from the flash memory controller 102, and the pin connections cannot be swapped (e.g., the pin D0 of the flash memory controller 102 is connected to the pin D4 of the flash memory chip 104, and the pin D4 of the flash memory controller 102 is connected to the pin D0 of the flash memory chip 104). Therefore, because there is a one-to-one relationship between the pins D0-D7 of the flash memory controller 102 and the pins D0-D7 of the flash memory chips 104 and 106, it is inconvenient when determining a layout of a circuit board. That is, a multi-layer circuit board may be required or the circuit board may need more via holes and complex routing, causing increased design and manufacturing costs.

### SUMMARY OF THE INVENTION

It is therefore an objective of the present invention to provide an electronic device having a plurality of allocations for data transmission, a controller for accessing a plurality of chips via at least one bus, and a method for accessing a plurality of chips via at least one bus, which can effectively lower a complexity of a circuit board layout so as to decrease design and manufacturing costs and solve the above-mentioned problems.

According to one embodiment of the present invention, an electronic device comprises a plurality of chips, and at least a bus and a controller, where the plurality of chips comprise a first chip and a second chip, the bus comprises a plurality of data lines, the controller couples to the plurality of chips via the bus, and the controller is utilized for accessing the plurality of chips. The controller determines an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

According to another embodiment of the present invention, a controller for accessing a plurality of chips via at least a bus is disclosed, where the bus comprises a plurality of data lines, and the controller comprises a storage unit and a microprocessor. The storage unit is utilized for storing a plurality of allocations for data transmission corresponding to the plurality of chips, respectively, where each of the allocations for data transmission is an arrangement of a plurality of bits of external data transmitted on the plurality of data lines. The microprocessor is utilized for accessing the plurality of chips, and selecting one of the allocations for data transmission according to information about which chip the external data will be written to, and transmitting the external data to the chip according to a selected allocation for data transmission.

According to another embodiment of the present invention, a method for accessing a plurality of chips via at least a bus is disclosed, where the plurality of chips comprise a first chip and a second chip, and the bus comprises a plurality of data lines. The method comprises: receiving external data; and determining an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art flash memory controller connecting to a plurality of flash memory chips via a bus.

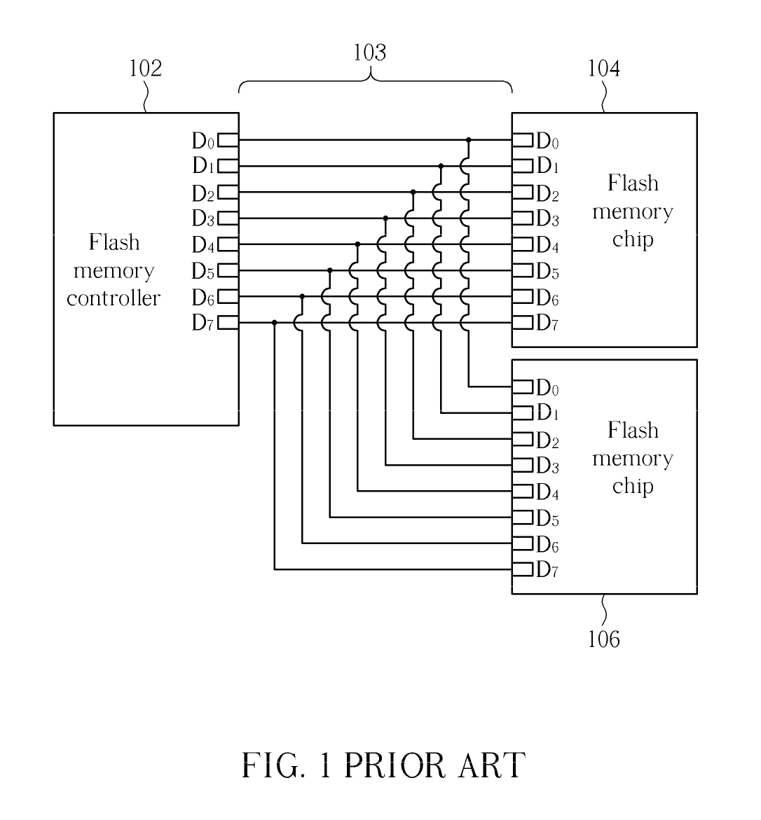

FIG. 2 is a diagram illustrating a flash memory device according to one embodiment of the present invention.

FIG. 3 is a diagram illustrating the flash memory controller, the plurality of data buses and the flash memory chip group shown in FIG. 2.

FIG. 4 is a diagram illustrating the flash memory controller, the data bus 228_1 and the flash memory chips 230_1 and 230_2 shown in FIG. 3.

FIG. 5 is a flowchart of a method for accessing a plurality of chips via at least a bus according to one embodiment of the present invention.

### DETAILED DESCRIPTION

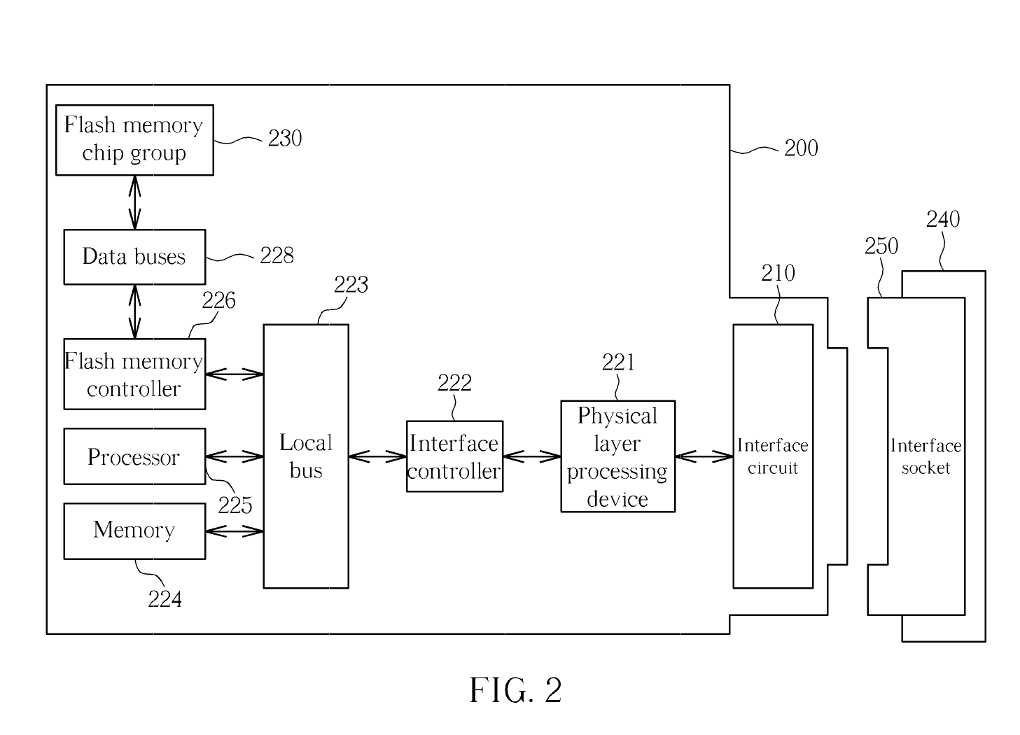

Please refer to FIG. 2. FIG. 2 is a diagram illustrating a flash memory device 200 according to one embodiment of the present invention. As shown in FIG. 2, the flash memory device 200 includes an interface circuit 210, a physical layer processing device 221, an interface controller 222, a local bus 223, a memory 224, a processor 225, a flash memory controller 226, a plurality of data buses 228 and a memory chip group (in this embodiment, the memory chip group is a flash memory chip group 230). In addition, the interface circuit 210 can be one of a SATA (Serial Advanced Technology Attachment) interface, a USB (Universal Serial Bus) interface and a PCIE (Peripheral Component Interconnect Express) interface, or a combinational interface which includes at least two of the SATA interface, the USB interface and the PCIE interface. In addition, according to the standard of the interface 210, the physical layer processing device 221 can be one of SATA, USB, PCIE physical layer processing devices, or a combinational physical layer processing device which includes at least two of the SATA, USB and PCIE physical layer processing devices. The interface controller 222 can also be determined as one of SATA, USB, PCIE interface controllers, or a combinational interface controller which includes at least two of the SATA, USB and PCIE interface controllers according to the standard of the interface circuit 210. In addition, the flash memory device 200 can be a portable memory device, and can be connected to an interface socket 250 of a computer host 240.

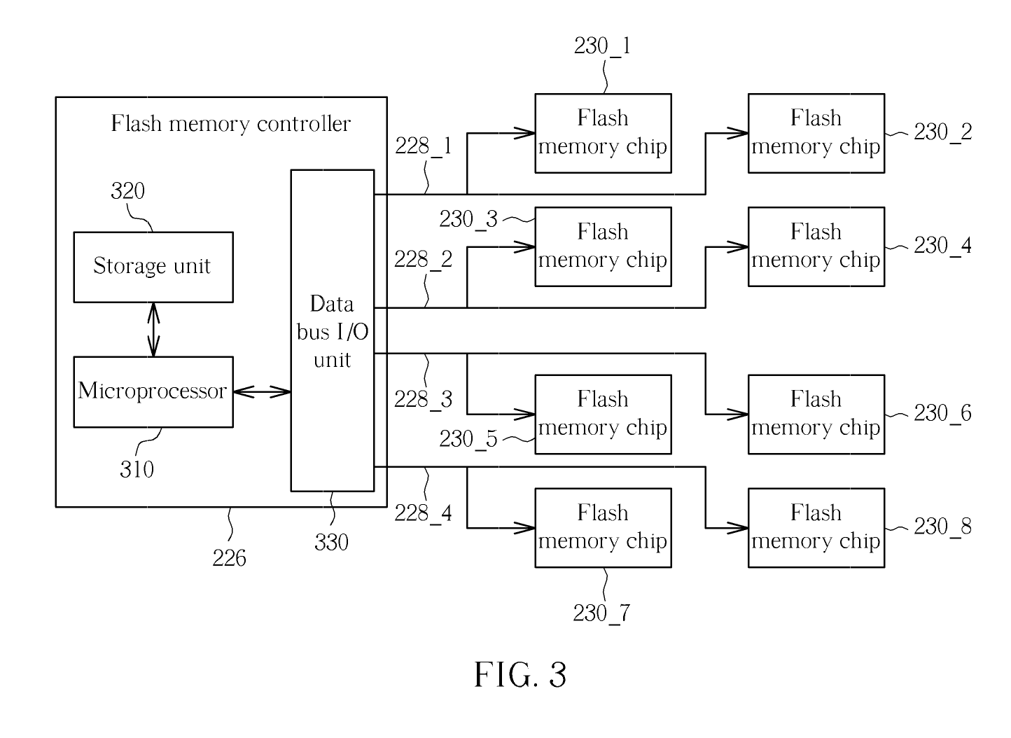

Please refer to FIG. 3. FIG. 3 is a diagram illustrating the flash memory controller 226, the plurality of data buses 228 and the flash memory chip group 230 according to one embodiment of the present invention. As shown in FIG. 3, the flash memory controller 226 comprises a microprocessor 310, a storage unit 320 and a data bus input/output unit 330, and the flash memory controller 226 are electrically connected to the flash memory chips 230_{—1}-230_8 via the data buses 228_{—1}-228_4, respectively. In addition, each of the data bus 228_{—1}-228_4 comprises a plurality of data lines (in this embodiment, each of the data bus 228_{—1}-228_4 comprises eight data lines L1-L8), and the storage unit 320 is used for storing a plurality of allocations for data transmission corresponding to the flash memory chips 230_{—1}-230_8, where each of the plurality of allocations for data transmission is an arrangement of a plurality of bits of external data transmitted on the plurality of data lines. For example, the flash memory chip 230_1 corresponds to a first allocation for data transmission, and data D0-D7 is transmitted from the computer host 240 to the flash memory chip 230_1 via the data lines L1-L8, respectively. In addition, the flash memory chip 230_2 corresponds to a second allocation for data transmission, and data D0-D7 is transmitted from the host 240 to the flash memory chip 230_1 via the data lines L8, L7, L6, L5, L4, L3, L2, L1, respectively.

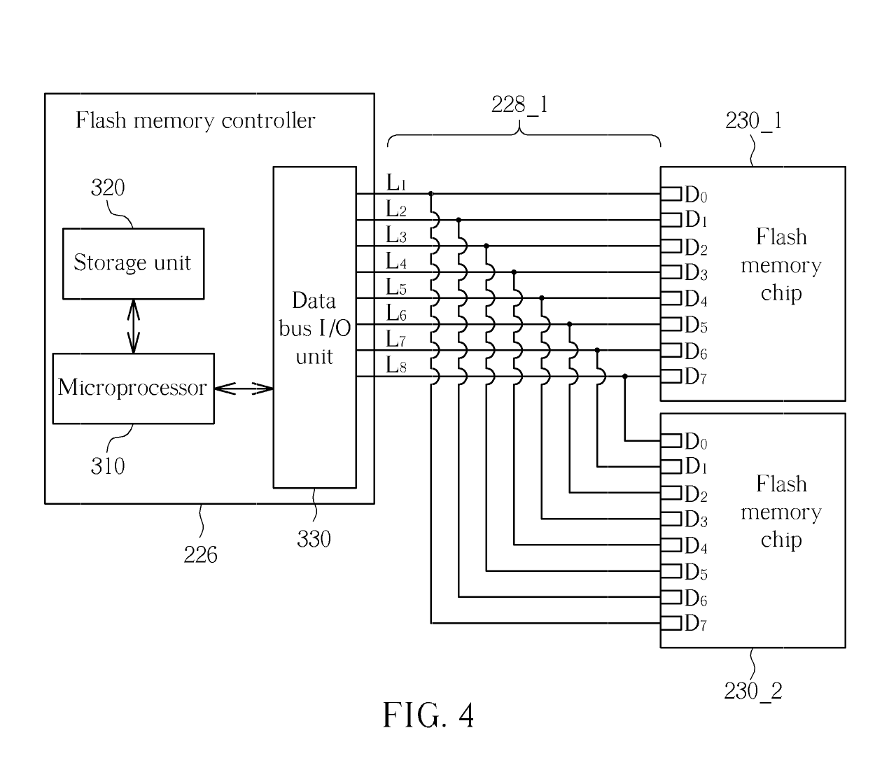

Following is an example for describing operations of the flash memory controller 226, the bus 228_1 and the flash memory chips 230_1 and 230_2 shown in FIG. 3 in detail. Please refer to FIG. 4. First, the microprocessor 310 receives external data from the computer host 240, and determines an allocation for data transmission of the external data transmitted on the data lines L1-L8 according to information about which flash memory chip (230_{—1}-230_8) the external data will be written to. Assuming that the external data will be written to the flash memory chip 230_1 shown in FIG. 4, the microprocessor 310 selects a first allocation for data transmission from the storage unit 310, where the first allocation for data transmission corresponds to the flash memory chip 230_1, and the microprocessor 310 controls the data bus input/output unit 330 to transmit the bits D0-D7 of the external data to the flash memory chip 230_1 via the data lines L1-L8, respectively. Assuming that the external data will be written to the flash memory chip 230_2, the microprocessor 310 selects a second allocation for data transmission from the storage unit 310, where the second allocation for data transmission corresponds to the flash memory chip 230_2, and the microprocessor 310 controls the data bus input/output unit 330 to transmit the bits D0-D7 of the external data to the flash memory chip 230_2 via the data lines L8-L1, respectively. Therefore, because the flash memory chips 230_1 and 230_2 receive the same bit of external data via different data lines (e.g., the flash memory chip 230_1 receives the bit D0 of the external data via the data line L1, while the flash memory chip 230_2 receives the bit D0 of the external data via the data line L8), and the data bus input/output unit 330 can dynamically determine on which data lines the bits D0-D7 of the external data should be transmitted. Therefore, the layout between the flash memory chips 230_1, 230_2 and the flash memory controller 226 is more flexible, and the designer can efficiently lower the complexity of the circuit board layout, and decrease the design and manufacturing costs of the circuit board.

It is noted that the flash memory device 200 shown in FIGS. 2-4 is an embodiment, and not a limitation of the present invention. In other embodiments of the present invention, the flash memory device 200 can be any other type of storage device, and the flash memory chips 230_{—1}-230_8 can be any other type of storage chip. Particularly, the data bus of the storage device is not only for transmitting data (i.e., the data bus can transmit a command signal, an address signal and required data to the storage chip at the same time). The present invention lowers the complexity of the circuit board layout, and these alternative designs also fall within this scope.

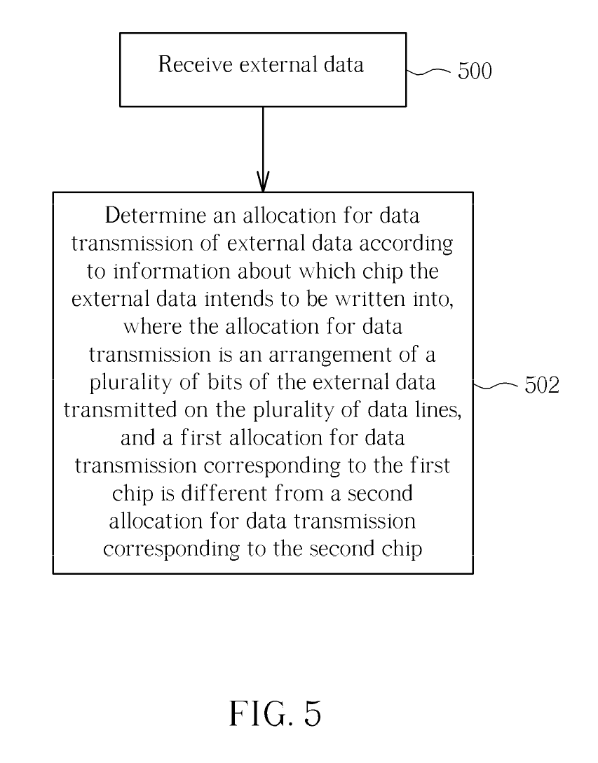

Please refer to FIG. 5. FIG. 5 is a flowchart of a method for accessing a plurality of chips via at least a bus according to one embodiment of the present invention, where the plurality of chips include a first chip and a second chip, and the bus includes a plurality of data lines. Referring to FIG. 5, the flow is described as follows:

Step 500: receive external data.

Step 502: determine an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

Briefly summarized, in the electronic device, the controller for accessing the plurality of chips via at least one bus, and the method for accessing the plurality of chips via at least one bus of the present invention, an allocation for data transmission of external data is determined according to information about which chip the external data will be written to. Therefore, the flexibility of the layout on the circuit board is increased, and the design and manufacturing cost is decreased.

Those skilled in the art will readily observe that numerous modifications and alterations of the device and method may be made while retaining the teachings of the invention.

What is claimed is:

1. An electronic device, comprising:
a plurality of chips, comprising a first chip and a second chip;
at least a bus, wherein the bus comprises a plurality of data lines; and
a controller, coupled to the plurality of chips via the bus, for accessing the plurality of chips, and determining an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

2. The electronic device of claim 1, wherein each of the plurality of chips is a memory chip, and the controller is a memory controller.

3. The electronic device of claim 2, wherein the memory chip is a flash memory chip.

4. The electronic device of claim 1, wherein the controller determines the allocation for data transmission by using a look-up table.

5. A controller for accessing a plurality of chips via a bus, wherein the bus comprises a plurality of data lines, the controller comprising:
a storage unit, for storing a plurality of allocations for data transmission corresponding to the plurality of chips, respectively, where each of the allocations for data transmission is an arrangement of a plurality of bits of external data transmitted on the plurality of data lines; and
a microprocessor, for accessing the plurality of chips, and selecting one of the plurality of allocations for data transmission according to information about which chip the external data will be written to, and transmitting the external data to the chip according to a selected allocation for data transmission.

6. The controller of claim 5, wherein each of the plurality of chips is a memory chip, and the controller is a memory controller.

7. The controller of claim 6, wherein the memory chip is a flash memory chip.

8. The controller of claim 5, wherein the plurality of allocations for data transmission comprise at least two different allocations for data transmission which correspond to two different chips of the plurality of chips, respectively.

9. A method for accessing a plurality of chips via a bus, wherein the plurality of chips comprise a first chip and a second chip, and the bus comprises a plurality of data lines, the method comprising:
receiving external data; and
determining an allocation for data transmission of external data according to information about which chip the external data will be written to, where the allocation for data transmission is an arrangement of a plurality of bits of the external data transmitted on the plurality of data lines, and a first allocation for data transmission corresponding to the first chip is different from a second allocation for data transmission corresponding to the second chip.

10. The method of claim 9, wherein each of the plurality of chips is a memory chip, and the controller is a memory controller.

11. The method of claim 10, wherein the memory chip is a flash memory chip.

12. The method of claim 9, wherein the step of determining the allocation for data transmission of external data comprises:
determining the allocation for data transmission by using a look-up table.
